(19) United States
(12) Patent Application Publication
(10) Pub. No.: US 2020/0279010 A1
(43) Pub. Date: Sep. 3, 2020

(54) RULE-BASED CONTENT CACHING

(71) Applicant: salesforce.com, inc., San Francisco, CA (US)

(72) Inventors: Marcus Lenzner, Jena (DE); Benjamin Siegmund, Jena (DE)

(21) Appl. No.: 16/290,161

(22) Filed: Mar. 1, 2019

(51) Int. Cl. G06F 16/957; G06F 16/9535; G06F 16/958; H04L 9/06; G06F 17/22

(52) U.S. Cl. CPC G06F 16/9574; G06F 16/9577; G06F 17/2247; G06F 16/972; H04L 9/0643; G06F 16/9535

(57) ABSTRACT

Delivering web pages in a rule-based content caching system includes receiving a request for a web page from a requesting customer, generating a visibility fingerprint for the web page based on web page components and one or more visibility rules, determining if a web page identified by the visibility fingerprint is in a cache, getting the web page from the cache when the web page identified by the visibility fingerprint is in the cache, when the web page identified by the visibility fingerprint is not in the cache, rendering the web page based on the web page components and the visibility rules and storing the web page in the cache, and returning the web page to the requesting customer.

### TECHNICAL FIELD

One or more implementations relate to the field of world wide web (WWW) pages, and more specifically, to web page creation and delivery.

### BACKGROUND

Online merchants can assemble content that is going to be rendered as part of a web page visible to a customer on a web site (e.g., a business to consumer (B2C) storefront online shopping page). This assembly process typically consists of combining multiple web page components in order to present a frequently changing visual experience to shopper. For example, the merchant may have a new advertising campaign to be scheduled for the upcoming holiday season and wants to build a landing page for this purpose. This landing page will likely contain may web page components, for example, multiple product tiles to promote products, a carousel of top selling products, a blog article describing product features and capabilities, and perhaps even content directed to certain demographic groups, and so on. One challenge is how to design and then efficiently serve these web pages to users in an extremely high demand environment (e.g., Black Friday or Cyber Monday shopping, etc.).

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a diagram of an example arrangement of web page processing according to an embodiment.

FIG. 2 is a flow diagram of web page processing according to an embodiment.

FIG. 3 is a flow diagram of fingerprinted web page processing according to an embodiment.

FIG. 4 is a flow diagram of generating a web page fingerprint according to an embodiment.

FIG. 5 illustrates an electronic device according to some implementations.

FIG. 6 shows a block diagram of an example of a computing environment in which rule-based content caching may be used in accordance with some implementations.

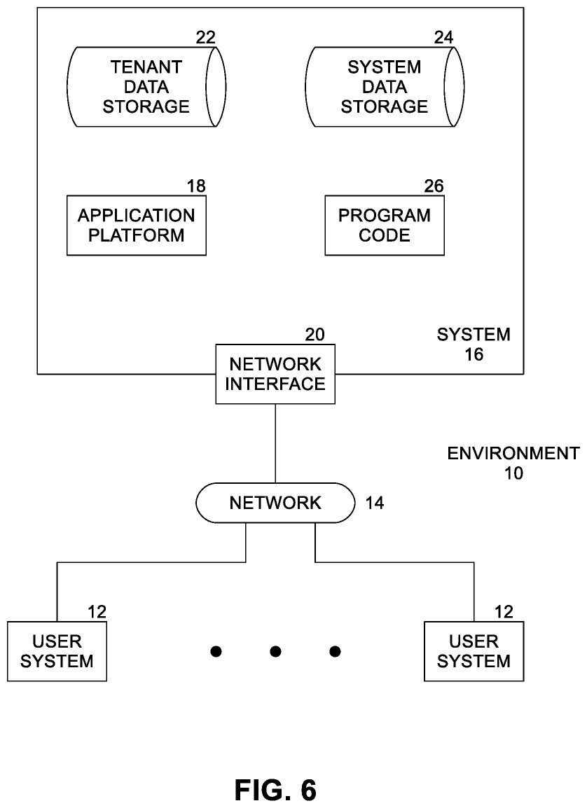

### DETAILED DESCRIPTION

The following description describes a method and apparatus for designing and delivering web pages in an efficient and scalable manner. In embodiments, rule-based caching is used to improve system efficiency in delivering web pages to requesting consumer devices. Prior to caching, a web page is processed to generate a unique digital “visibility fingerprint” for a given set of web page components making up a web page. Once a visibility fingerprint has been generated for the web page, the web page may be accessed from a web page cache by reference to the fingerprint.

Proprietors of e-commerce web sites assemble web page content that is going to be rendered as part of a web page visible to customers. This assembly process typically consists of creating and/or selecting multiple components (e.g., text, images, videos, logos, product information, advertisements, reviews, etc.) in order to present a visual experience to the online shopper. In many cases, the web pages are changed frequently in order to keep the content fresh and engaging for the customer. In other situations, the web pages are updated to reflect changing business conditions, advertising campaigns, promotions, and seasons. For example, the merchant may have a set of web pages for the upcoming holiday season. Each web page contains multiple components. One challenge is that some of those components of the web page may be controlled by one or more rules that control their visibility. For example, one rule may specify that one of the product tiles on the web page should be visible on a specific day during an advertising campaign time frame (e.g., Black Friday, Cyber Monday) and for another rule a certain product tile should only be visible to customers that belong to a selected customer segment (e.g., big spender customers, only men, only students from Texas, customers who have previously purchased certain products, etc.).

In one embodiment, a web page designer application helps merchants with the process of designing web pages and provides the capability to define such visibility rules for the whole web page or even separately for any of the components on the page. This may result in a proliferation of versions of web pages being generated and delivered to certain sets of customers as required. One problem is that with the proliferation of web page versions, system performance for delivery of those pages is often negatively impacted (sometimes severely). Web pages can be cached by a web server in order to provide frequently requested pages to customers in an efficient manner. However, when the web page versions proliferate, this may result in a “cache explosion” (e.g., constantly updating a full cache) bringing system performance down to a crawl. Therefore, a high-performance solution for web page rendering is desired that respects rule driven rendering (e.g., deliver the right components of the page based on a given audience within the constraints of customer segment, time, geography, past purchases, etc.), but that keeps pace with rapidly changing web page versions and customer demand for delivery of web pages.

A high-performance solution in this context means providing fast response times even during peak load (such as flash sales on Black Friday or Cyber Monday, for example). In an embodiment, intelligent caching is used to meet this requirement. In one embodiment a visibility fingerprint is generated for a web page for a given audience and point in time. This means that for the same point in time but for different customers (e.g., one is a big spender and the other one is not, one comes from Texas and the other one from Florida, . . . ), or the same audience but for different points in time, there are potentially portions of the web page that may look different to a given customer based on the rules defined by the merchant as applied to web page requests in real-time. The visibility fingerprint calculation identifies those differences by analyzing the components of the page that have rules applied, even before page rendering occurs. The rendering is then performed in the context of that visibility fingerprint. Therefore, different visibility fingerprints and associated fingerprinted web pages can be independently cached, where identical visibility fingerprints always refer to the same cache entry (e.g., a rendered fingerprinted web page). In this way the web page rendering result of a previously executed rendering cycle may be reused, if applicable, as opposed to rendering everything on the web page from scratch again even though the context did not change. This results in a significant positive performance impact for delivery of web pages to the customer's consumer devices and deters cache explosion.

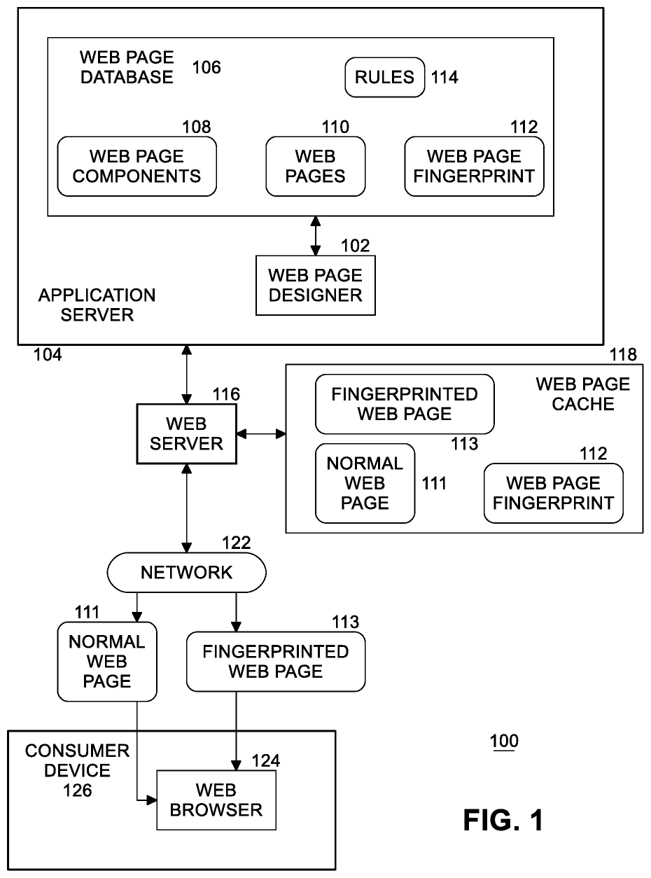

FIG. 1 is a diagram of an example arrangement 100 of web page processing according to an embodiment. Application server 104 is a computer server that resides in a data center, either one managed by the merchant or by a cloud service provider (CSP). In an embodiment, application server 104 executes code to create hyper-text markup language (HTML) output. In an embodiment, application server 104 is not directly accessible by customers over a network such as the Internet. There may be multiple application servers managed by a CSP. An application server 104 includes a web page designer application 102. Web page designer application 102 is an application program used by the merchant (or by a web site developer contracted to design the web site for the merchant) to design web pages 110 for an on-line storefront (e.g., a merchant web site for selling goods (e.g., products) to customers). The merchant assembles one or more web pages 110 during the design process from multiple web page components 108 using web page designer 102. Web pages 110 include code and/or data that define the web site's format, function and visual appearance. A web page is an assembly of components that can be rendered on the web site. Web pages may be of different page types. A page type includes a definition of a layout and code to produce HTML descriptions of the layout. As used herein, a web page type may be fingerprinted (e.g., identified by a visibility fingerprint) or normal (e.g., not fingerprinted).

In an embodiment, the merchant's web site is run on a cloud computing platform provided by the CSP. Application server 104 includes a web page database 106, which may be integral with the application server or accessible by application server 104 within a cloud computing platform. Web page database 106 includes web pages 110 and web page components 108. Web page components 108 include content items that can be created, selected, and/or configured by the merchant, such as text, images, videos, logos, product codes, product images, banners, advertisements, and so on. Components may include other components in a nested manner. A component may be categorized according to a component type. A component type is a definition of configuration options, and code that produces a markup of a component. The component type may define sub-layouts for nested components.

Web page database 106 includes one or more visibility rules 114. In an embodiment, visibility rules 114 include visibility conditions for one or more components in web page components 108 and web pages 110. Visibility rules 114 are used by web page designer 102 to determine when and under what conditions web page components 108 are to be included and/or visible in web pages 110 to a specific customer at a specific time. Conditions can be based on one or more of any characteristics, customer attributes, demographic information, time, geographic location, Internet Protocol (IP) address, interests, or any other data. In an embodiment, visibility is based on a schedule (e.g., only visible during the holiday season). In an embodiment, visibility is based on defined customer segments (e.g., only visible for male customers from Wyoming). In an embodiment, the customer segments are defined statically by the merchant, dynamically based on changing conditions, or based on rules themselves. For example, rules for customer segments can define customers from certain countries based on geolocation or an address, customers of a certain gender, customers who spent a certain amount of money with the merchant (which could be limited by time), customers who normally order a certain amount of products at one time, customers who visited the web site a certain number of times in a selected time period, customers who clicked on a particular advertisement, customers whose birthday is today, this week, or this month, customers who put a certain number of products in their online shopping basket but never bought them, or customers who make many product returns, and so on. Any rules defining customer segments or otherwise describing customers may be used.

Application server 104 communicates with web server 116. Web server 116 is a computer server that performs caching of web pages, delivery of web pages, load balancing, and secure socket layer (SSL) termination operations. In some embodiments, a plurality of application servers 104 can be coupled with web server 116, and a plurality of web servers 116 can be coupled with an application server. In an embodiment, web server 116 is operated by a CSP. Web server 116 is coupled to network 122 (such as the Internet, for example) for sending web pages to a customer's consumer device 126 as is well known in the art. Consumer device 126 is a computing device such as a personal computer (PC), smart phone, tablet computer, laptop computer, personal digital assistant (PDA), electronic book reader, smart television display, shopping kiosk, or other computing device for running web browser 124 to display web pages 110.

Web server 116 is coupled with web page cache 118. In an embodiment, web page cache 118 is a database in a cloud computing platform provided by the CSP or by the merchant. Web page cache 118 stores web pages for efficient delivery to consumer devices 126. In an embodiment, application server 104 may be combined with web server 116, and web page database 106 and web page cache 118 may be combined into one database.

In one known approach to delivering web pages specific to a customer (e.g., tailored to the unique customer or customers of a certain customer segment), a customer operating web browser 124 on consumer device 126 navigates to the merchant's web site. In response to a request for a web page from the web site by the browser, web server 116 checks web page cache 118 for the requested web page (via a uniform resource locator (URL)). If the web page is not in the cache, web server 116 requests the web page from application server 104. Application server 104 renders the requested page, but since the rendered web page is specific to the customer, application server 104 marks the web page as non-cacheable and sends the web page to web server 116. Web server 116 delivers the web page to web browser 124 on consumer device 126 but does not cache the web page in web page cache 118 (since it's marked as non-cacheable). This approach is not viable for large scale usage because it creates too much processing load on application server 104 and every time the same web page is requested the web page has to be rendered. The negative performance impact is typically unacceptable.

In another known approach to delivering web pages specific to a customer, a customer operating web browser 124 on consumer device 126 navigates to the merchant's web site. In response to a request for a web page from the web site, web server 116 checks a generic cache in web page cache 118 for the requested web page (via the uniform resource locator (URL)). If the web page is not in the generic cache, web server 116 asks application server 104 for a “personalization hash.” A personalization hash can be created based on membership in a customer segment. Web server 116 then checks a personalized cache in web page cache 118 corresponding to the personalization hash. If the requested personalized web page is not in the personalized cache, web server 116 requests the personalized web page from application server 104. Application server 104 renders the requested personalized web page (e.g., specific to the customer and/or customer segment) and forwards the personalized web page to web server 116. Web server 116 creates a personalized cache entry for the personalized web page and delivers the personalized web page to browser 124 in consumer device 126. This approach is also not viable for large scale usage because it typically creates too many cache entries in web page cache 118. For example, a merchant web site with 20 different customer segments can create 2²⁰ (1,048,576) different personalization hashes (exhibiting exponential asymptotic growth), even if most of these possibilities would not have an influence on the contents of the requested personalized web page.

To overcome these difficulties, in embodiments web page designer 102 generates a unique web page fingerprint 112 for a web page 110. When a web page 110 has been “fingerprinted” the web page is known herein as a fingerprinted web page 113. A web page without a fingerprint is known herein as a normal web page 111. Web server 116 stores normal web pages 111 (e.g., those without a fingerprint), fingerprinted web pages 113, and web page fingerprints 112 in web page cache 118. Application server 104 renders fingerprinted web pages 113 based at least in part on one or more visibility rules 114 and web page components 108 in response to requests from web server 116 for web pages to satisfy requests from web browser 124 of consumer device 126.

In an embodiment, the fingerprint calculation process automatically derives the web page cache 118 entry from the given merchant authored data (e.g., fingerprinted web page 113 and web page components 108 with visibility rules) and context (such as point in time, customer segments) and therefore does not require any additional coding efforts for the developers of the web page and web page components. This approach also does not require any technical know-how on the merchant end regarding the visibility of any page and constituent components. Embodiments are driven by an extensible set of visibility rules 114 and the fingerprint calculation can adapt any future rule without impacting the merchant's web site implementation. The visibility fingerprint calculation adheres not just to the visibility rules per page and components but also to the structure of an assembly of components. Embodiments support arbitrary nesting of components and support the order of elements within a component hierarchy. Because the visibility fingerprint is based on the actual visibility to the customer, the same rendering result will always get the same visibility fingerprint, even if the contexts are different (thus effectively preventing cache explosion).

For example, assume customer A is in a customer segment called “men” and customer B is in a customer segment called “women.” In the known personalization hash approach, this would lead to a different personalization hash being generated for each of customer A and B, thus resulting in generation of two different web page cache entries. However, if the rendered page is not specific to “men: and “women” in any way it is pointless to create two web page cache entries because the rendering result would be identical. Thus, rendering the same page twice is a waste of 50% computation time and having two cache entries backed by the identical rendering result is a waste of 50% disk space effectively. The present visibility fingerprint mechanism defuses this problem because web page designer 102 determines that the page for customer A and B is identical, thus generating the same fingerprint, therefore web page designer renders the page only once and also creates just one web page cache entry (instead of two). When more customer segments are taken into account the possible number of combinations of customer segments per customer underlies an asymptotic exponential growth as described above. The savings in time and disk space using the present fingerprinting method comes at a cost of calculating the fingerprint itself, but since this is faster than the rendering operation this results in better overall performance than the known personalization hash-based approach, for the scenario depicted above.

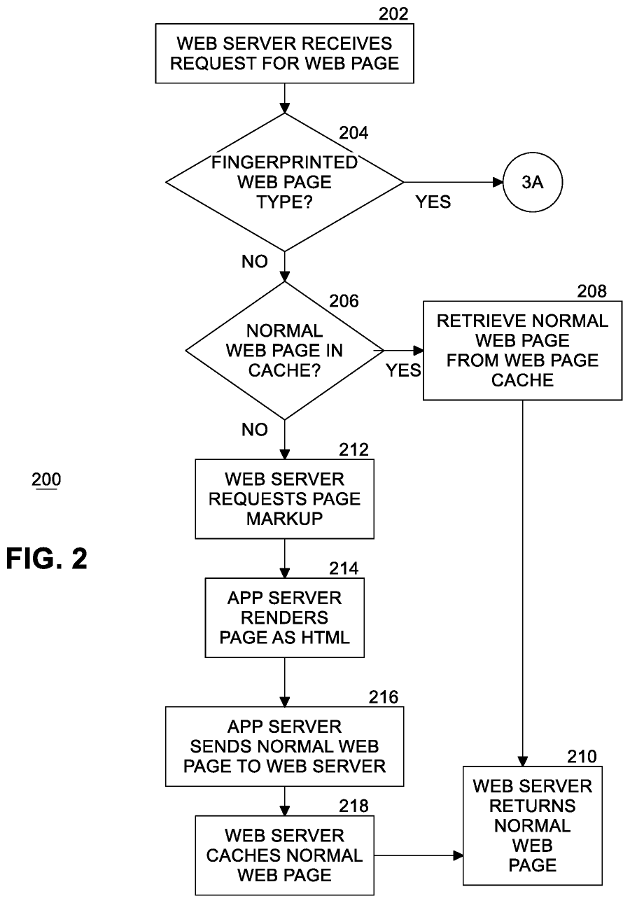

FIG. 2 is a flow diagram 200 of web page processing according to an embodiment. Initially, a customer operating browser 124 on consumer device 126 navigates to the merchant's web site. At block 202, web server 116 receives a request for a web page from the browser. At block 204, if the web page is not a fingerprinted web page type (e.g., the web page is a normal web page 111), then processing continues with block 206. At block 206, if the normal web page 111 being requested is in web page cache 118, then at block 208 web server 117 retrieves the normal web page 111 from web page cache 118. Next, at block 210, web server 116 returns the normal web page to consumer device 126. If the requested normal web page is not in the cache at block 206, processing continues with block 212 where the web server requests a page markup from application server 104. At block 214, application (App) server renders the requested normal web page 111 as HTML based at least in part on web page components 108 and visibility rules 114. At block 216, application server sends normal web page 111 to web server 116. At block 218, web server 116 caches normal web page 111 in web page cache 118 for future reuse. At block 210, web server 116 returns normal web page 111 to consumer device 126. In an embodiment, blocks 218 and 210 may be performed in any order (e.g., block 218 then block 210, or block 210 and then block 218).

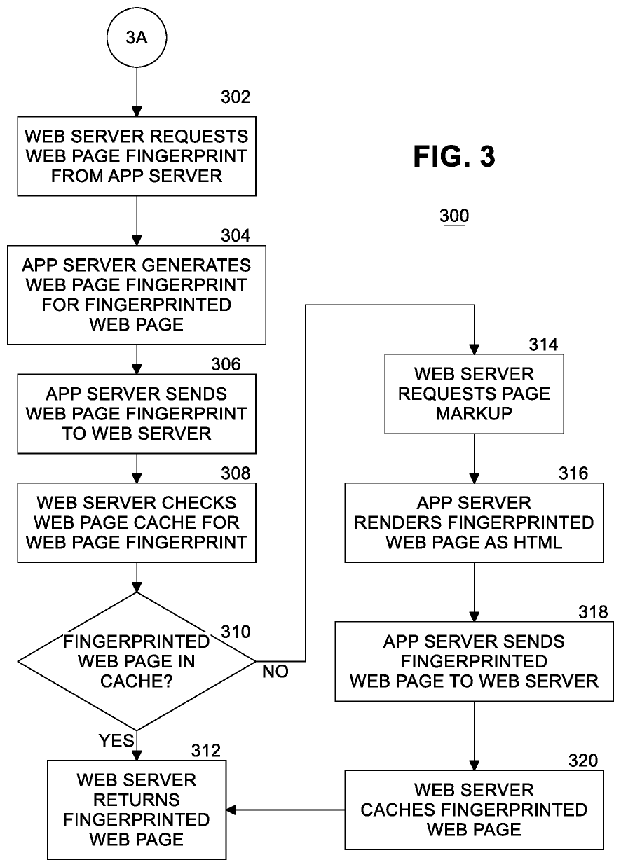

The typical processing described for normal web pages can be improved upon in embodiments of the present invention by utilizing visibility fingerprints. At block 204, if the requested web page is a fingerprinted web page type, then processing continues with block 302 on FIG. 3.

FIG. 3 is a flow diagram 300 of fingerprinted web page processing according to an embodiment. In embodiments, a web page fingerprint is used to uniquely identify a web page of a fingerprinted web page type. At block 302, web server 116 requests a web page fingerprint 112 to be generated by application server 104 for the received web page request. At block 304, application server 104 generates the web page fingerprint 112 for the fingerprinted web page 113 based at least in part on visibility rules 114, web page components 108, and membership in customer segments. Generating the web page fingerprint can be performed more quickly than rendering the fingerprinted web page. In an embodiment, application server 104 stores web page fingerprint 112 in web page database 106 for future reuse (thus future requests for the fingerprint do not result in additional application server processing to regenerate the fingerprint). At block 306, application server 104 sends web page fingerprint 112 to web server 116. At block 308, if the fingerprinted web page 113 identified by web page fingerprint 112 is in web page cache 118 (since the fingerprinted web page was stored during processing of a previous request), then web server 116 at block 312 retrieves the identified fingerprinted web page from the cache and returns the fingerprinted web page to consumer device 126. If the fingerprinted web page is not in the web page cache as indicated by the web page fingerprint received from the application server at block 310, then processing continues with block 314.

At this juncture, the fingerprinted web page is not in the web page cache and must be rendered on the application server. At block 314, web server 116 requests the page markup to be rendered by application server 104. At block 316, application server 104 renders the page as HTML based at least in part on web page components 08 and visibility rules 114. At block 318, application server 104 sends the rendered fingerprinted web page to web server 116. At block 320, web server caches fingerprinted web page 113 in web page cache 118. Processing continues with block 312, where web server 116 returns the fingerprinted web page to the consumer device. When future requests for the same web page are received, the fingerprinted web page will already be in the web page cache and can be identified and referenced by the web page fingerprint. Since generating the fingerprint is faster and less computationally intensive than rendering the fingerprinted web page, overall system processing speed and throughput is improved. In an embodiment, blocks 312 and 320 may be performed in any order (e.g., block 320 then block 312, or block 312 and then block 320).

In an embodiment, the visibility fingerprint is created by traversing the components of the page and creating a textual representation of the visible components. This representation is then hashed to create the fingerprint (e.g., as a unique signature of the page). In one example, a textual representation may be:

pageID [top.(headline), main.(bannerA, 2column[left(productA), right(productB)])]

The fingerprint contains all visible components and basic information about the logical page structure, such as where in the layout each component is, the order of components that fill into the same layout slot, and how components are nested within each other. When multiple customers get the same resulting structure, they get the same fingerprint and therefore a cached result can be used. Only actual differences in the page will result in creating different fingerprints, so each version is only cached once, preventing a useless creation of duplicate cache entries.

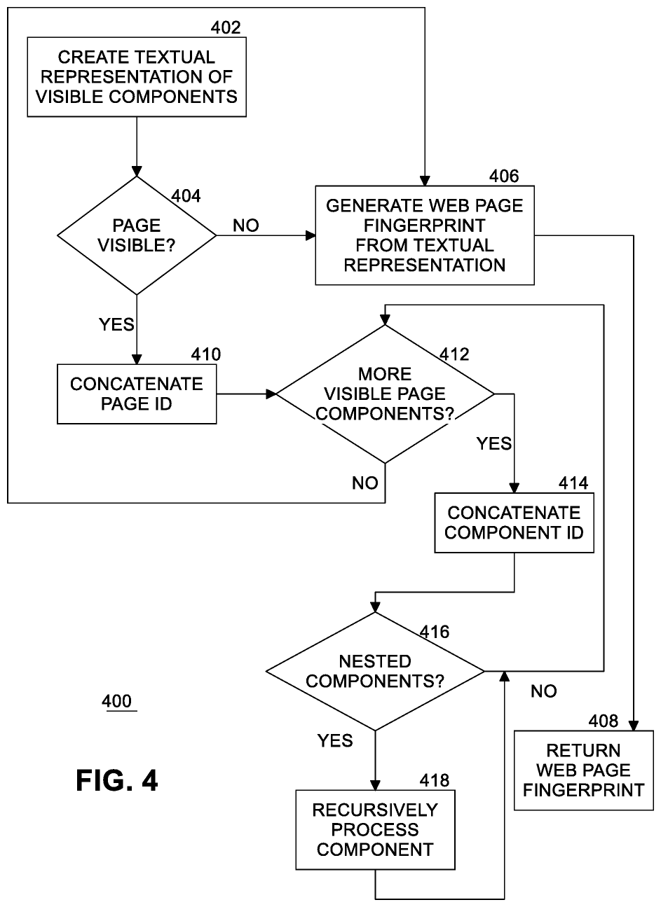

FIG. 4 is a flow diagram 400 of generating a web page fingerprint 112 according to an embodiment. At block 402, application server 104 creates a textual representation of the visible components of fingerprinted web page 113. If the page is not visible at block 404, then processing continues at block 406 where application server 104 generates web page fingerprint 112 from the textual representation. If components within the page are visible or not is irrelevant in the current processing if the page itself is not visible (which effectively prevents any traversal of the component hierarchy). The same is true when traversing the component hierarchy—if an invisible component is encountered then no further traversal into the respective component sub hierarchy is performed because it is already irrelevant for the rendering result. During page/component traversal processing of sub hierarchies that have an invisible root can be eliminated, which is beneficial for performance due to reduced data to crawl and guarantees that the fingerprint does not change if things in invisible sub hierarchies change (as this has no influence on the overall visibility).

Application server 104 then returns the web page fingerprint 112 to web server 116 at block 408. If the page is visible at block 404, processing continues with block 410, where application server 104 concatenates a page ID of the fingerprinted web page 113 with the textual representation. At block 412, if no more visible page components are yet to be processed, processing continues back at block 406. Otherwise, more page components need to be processed. In that case, at block 414 application server concatenates a component ID of the next component to the textual representation. At block 416, if there are nested components to the current component, application server 104 recursively processes the nested components at block 418. If there are no nested component of the current component, then processing continues with the next component at block 412. Thus, the web page can be processed to generate a unique web page fingerprint 112 for the current combination of components.

One or more parts of the above implementations may include software and/or a combination of software and hardware. An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), Flash memory, phase change memory, solid state drives (SSDs)) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists the code/data even when the electronic device is turned off (when power is removed), and the electronic device copies that part of the code that is to be executed by the processor(s) of that electronic device from the non-volatile memory into the volatile memory of that electronic device during operation because volatile memory typically has faster read/write times. As another example, an electronic device may include a non-volatile memory (e.g., phase change memory) to store the code/data when the electronic device is turned off, and that same non-volatile memory has sufficiently fast read/write times such that, rather than copying the part of the code to be executed into volatile memory, the code/data may be provided directly to the processor(s) (e.g., loaded into a cache of the processor(s)); in other words, this non-volatile memory operates as both long term storage and main memory, and thus the electronic device may have no or only a small amount of DRAM for main memory. Typical electronic devices also include a set of one or more physical network interface(s) to establish network connections (to transmit and/or receive code and/or data using propagating signals) with other electronic devices.

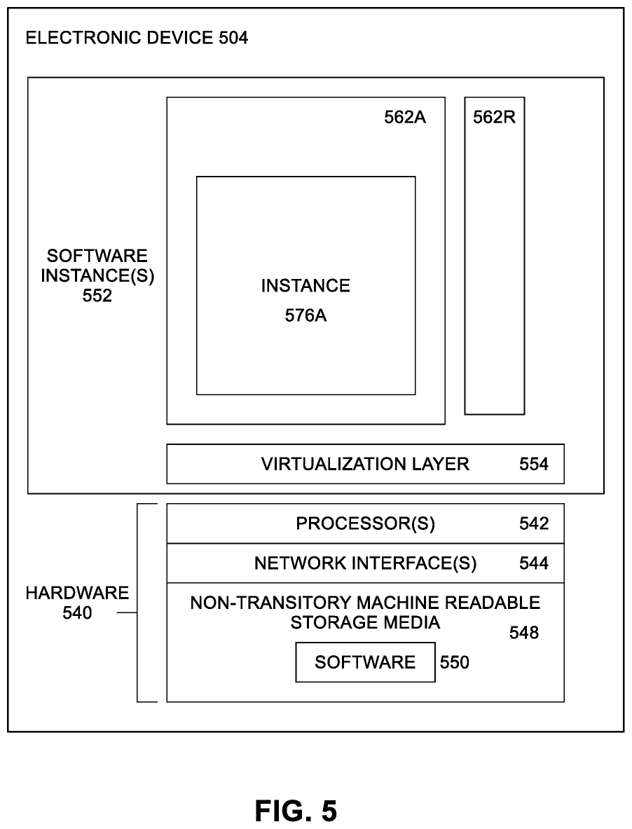

FIG. 5 illustrates an electronic device 504 according to some implementations. FIG. 5 includes hardware 540 comprising a set of one or more processor(s) 542, a set or one or more network interfaces 544 (wireless and/or wired), and non-transitory machine-readable storage media 548 having stored therein software 550. Each of the previously described application server 104, web server 116, and/or consumer device 126 may be implemented in one or more electronic devices 504. In one implementation, each of consumer devices is implemented in a separate one of the electronic devices 504 (e.g., in an end user electronic device operated by an end user; in which case, the software 550 in each such end user electronic device includes the software to implement one of the end user clients, including software to interface with a cloud computing service (e.g., an application programming interface (API), a web browser, a native client, a portal, a command-line interface, etc.)) and each of application server 104 and web server 116 is implemented in a separate set of one or more of the electronic devices 504 (in which case, the software 550 is the software to implement web page design and delivery of application server 104 (including web page designer 102) and web server 116; in operation, the end user electronic devices and the electronic device(s) implementing the cloud computing system containing application server 104 and web server 116 would be commutatively coupled (e.g., by a network) and would establish between them connections for requesting and providing cloud computing services. In an embodiment, application server 104 and web server 116 may be implemented in the same electronic device. Other configurations of electronic devices may be used in other implementations.

In electronic devices that use compute virtualization, the processor(s) 542 typically execute software to instantiate a virtualization layer 554 and software container(s) 562A-R (e.g., with operating system-level virtualization, the virtualization layer 554 represents the kernel of an operating system (or a shim executing on a base operating system) that allows for the creation of multiple software containers 562A-R (representing separate user space instances and also called virtualization engines, virtual private servers, or jails) that may each be used to execute a set of one or more applications; with full virtualization, the virtualization layer 554 represents a hypervisor (sometimes referred to as a virtual machine monitor (VMM)) or a hypervisor executing on top of a host operating system (OS), and the software containers 562A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 550 (illustrated as instance 576A) is executed within the software container 562A on the virtualization layer 654. In electronic devices where compute virtualization is not used, the instance 576A on top of a host operating system is executed on the “bare metal” electronic device 504. The instantiation of the instance 576A, as well as the virtualization layer 554 and software containers 562A-R if implemented, are collectively referred to as software instance(s) 552.

Alternative implementations of an electronic device may have numerous variations from that described above. For example, customized hardware and/or accelerators might also be used in an electronic device.

FIG. 7 shows a block diagram of an example of an environment 10 in which the present web page design and delivery operations may be used in accordance with some implementations. Computing environment 10 may include one or more user systems 12, network 14, and system 16, where system 16 includes application platform 18, network interface 20, tenant data storage 22, system data storage 24, and program code 26. In other implementations, environment 10 may not have all of these components and/or may have other components instead of, or in addition to, those listed above.

The system 16 includes hardware and software to implement application server 104 and/or web server 116 and/or web page cache 118. User systems 12 are electronic devices used by one or more users (such as consumer devices 126) that subscribe to services (e.g., web page delivery) provided by the cloud computing services implemented by the system 16. User systems 12 might interact via a network 14 with the system 16. Further, in one implementation, the system 16 is a multi-tenant cloud computing architecture supporting multiple services, such as software as a service (SaaS) (e.g., customer relationship management (CRM) service provided by Salesforce.com, Inc.), platform as a service (PaaS) (e.g., execution runtime, database, application development tools; such as Force.com®, Heroku™, and Database.com™ by Salesforce.com, Inc.), and/or infrastructure as a service (IaaS) (virtual machines, servers, storage). In some implementations, such a platform as a service allows for the creation, management and execution of one or more applications developed by the provider of the service, vendors accessing the service via user systems 12, or third-party application developers accessing the system 12. The system 16 may utilize methods for providing web page design and delivery, as described above. This allows for the system 16 to provide web page delivery in an efficient and scalable manner.

Network 14 is any network or combination of networks of devices that communicate with one another. For example, network 14 can be any one or any combination of a local area network (LAN), wide area network (WAN), telephone network, wireless network, point-to-point network, star network, token ring network, hub network, or other appropriate configuration. Network 14 can include a Transfer Control Protocol and Internet Protocol (TCP/IP) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

Each user system 12 is an end user electronic device, such as a desktop personal computer, workstation, laptop, personal digital assistant (PDA), tablet computer, cell phone, etc. Each user system 12 typically includes one or more user interface devices, such as a keyboard, a mouse, trackball, touch pad, touch screen, pen or the like, for interacting with a graphical user interface (GUI) provided on a display (e.g., a monitor screen, liquid crystal display (LCD), etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. User systems 12 might communicate with system 16 using TCP/IP and, at a higher network level, use other common Internet protocols to communicate, such as hyper-text transport protocol (HTTP), file transfer protocol (FTP), Andrew file system (AFS), wireless application protocol (WAP), etc. In an example where HTTP is used, user system 12 might include an HTTP client commonly referred to as a “browser” for sending and receiving HTTP signals to and from a server at system 16 allowing a user of user system 12 to access, process and view information, pages and applications available to it from system 16 over network 14. Such a server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. However, other alternative configurations may be used instead.

In one implementation, tenant data storage 22 is a multi-tenant database management system (DBMS). In a typical multi-tenant DBMS, a single instance of software may be used to store data from multiple vendors (also known as tenants) and each vendor is provided with a dedicated share of the software instance. The term “data record” generally refers to a data entity created by or on behalf of a vendor. A data record is comprised of a set of fields defined within a database. A database can be viewed as a collection of database objects, such as a set of logical tables, containing data fitted into predefined categories. A “table” is one representation of a database object, and may be used herein to simplify the conceptual description of database objects. In the context of a relational database, each relational database table generally contains one or more data categories logically arranged as columns according to a schema, where the columns of the relational database table are different ones of the fields from the plurality of data records, and where each row of the relational database table are different ones of a plurality data records and contains an instance of data for each category defined by the fields. In some implementations of a cloud database (a database that runs on a cloud platform and access to which is provided as a database service), each database object contains a plurality of data records having fields, where identifiers are used instead of database keys, and wherein relationships are used instead of foreign keys. Regardless, by way of example, a data record can be for a business partner or potential business partner of a vendor, and can include information describing an entire company, subsidiaries, and/or contacts at the company. As another example, a data record can be for a project that a vendor is working on, such as an opportunity (e.g., a possible sale) with an existing partner, or a project that the vendor is trying to get. As another example, a customer-relationship management (CRM) database may include: 1) a database object that describes a customer with fields for basic contact information such as name, address, phone number, fax number, etc.; and 2) another database object might describe a purchase order, including fields for information such as customer, product, sale price, date, etc.

In some implementations, the tenant data storage 22 includes one or more databases storing the vendor/tenant data (such as information about the vendor's customers/users, information about the vendor's products/services, marketing materials. Thus, in operation, a vendor, through a user system 12, causes the vendor/tenant data to be stored in the tenant data storage 22. In some implementations, a vendor can access system 16 through user system 12 to access its data stored in tenant data storage 22.

In some implementations, system data storage 24 stores system data 25 accessible to system 16 and possibly multiple tenants, while program code 26 (e.g., a runtime engine that materializes application data from metadata; that is, there is a clear separation of the compiled runtime engine (also known as the system kernel), tenant data, and the metadata that describes each application, which make it possible to independently update the system kernel and tenant-specific applications and schemas, with virtually no risk of one affecting the others) for implementing various functions of system 16. In such implementations, the tenant data storage 22, which is a multi-tenant database management system (DBMS), manages one or more databases storing the vendor/tenant data and vendor/tenant application metadata. The tenant data and the system data may be stored in various databases, such as one or more Oracle® databases.

In one implementation, application platform 18 includes an application setup mechanism that supports application developers' creation and management of applications (such as web page designer 102), which may be saved as metadata into tenant data storage by save routines. Invocations to such applications may be coded using procedural language for structured query language (PL/SQL) that provides a programming language style interface. Invocations to applications may be detected by one or more system processes, which manage retrieving application metadata for the subscriber making the invocation and executing the metadata as an application in a virtual machine.

In certain implementations, one or more servers of system 16 is configured to handle requests for any user associated with any organization that is a tenant. Because it is desirable to be able to add and remove servers from the server pool at any time for any reason, there is preferably no server affinity for a user and/or organization to a specific server. In one implementation, therefore, an interface system implementing a load balancing function is communicably coupled between the servers of system 16 and the user systems 12 to distribute requests to the servers. In one implementation, the load balancer uses a least connections algorithm to route user requests to the servers. Other examples of load balancing algorithms, such as round robin and observed response time, also can be used. For example, in certain implementations, three consecutive requests from the same user could hit three different servers, and three requests from different users could hit the same server. In this manner, by way of example, system 16 is multi-tenant, wherein system 16 handles storage of, and access to, different database objects, data and applications across disparate users and organizations.

In certain implementations, user systems 12 (which may be client systems) communicate with the servers of system 16 to request and update system-level and tenant-level data from system 16 that may involve sending one or more queries to tenant data storage 22 and/or system data storage 24. In one implementation of system 16, a server in system 16 automatically generates one or more SQL statements (e.g., one or more SQL queries) that are designed to access the desired information. System data storage 24 may generate query plans to access the requested data from the database.

In some multi-tenant database systems, tenants may be allowed to create and store custom objects, or they may be allowed to customize standard entities or objects, for example by creating custom fields for standard objects, including custom index fields. In certain implementations, for example, all data records of a custom data object are stored in a single multi-tenant physical table, which may contain multiple logical database objects per organization. It is transparent to customers of the system 16 that their multiple database objects are in fact stored in one large table or that their data may be stored in the same table as the data of other customers.

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue implementation.

References in the specification to “one implementation,” “an implementation,” “an example implementation,” “some implementations,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

1. A computing device configured to deliver web pages, the computing device comprising:
one or more processors; and
a non-transitory machine-readable storage medium having instructions stored therein,
which when executed by the one or more processors, causes the computing device to:
receive a request for a web page from a requesting customer;
generate a visibility fingerprint for the web page, prior to rendering the web page, based at least in part on web page components and one or more visibility rules accessed from a web page database, wherein generating the visibility fingerprint comprises traversing components of the web page, creating a textual representation of visible components, and hashing the textual representation;
determine if a web page identified by the visibility fingerprint is in a cache, prior to rendering the web page;
when the web page identified by the visibility fingerprint is not in the cache, render the web page based at least in part on the web page components and the visibility rules and store the web page in the cache;
retrieve the web page from the cache when the web page identified by the visibility fingerprint is in the cache;
and
return the web page to the requesting customer.

2. The computing device of claim 1, comprising instructions to apply the visibility rules defining conditions under which web page components are visible in the web page during rendering.

3. The computing device of claim 2, wherein the conditions define a segment of customers to receive the web page.

4. The computing device of claim 1, wherein the visibility fingerprint is unique for the web page.

5. The computing device of claim 1, wherein generating the visibility fingerprint is faster than rendering the web page.

6. (canceled)

7. The computing device of claim 61, wherein instructions to traverse the components of the web page comprise instructions to traverse nested components.

8. The computing device of claim 61, wherein instructions to create the textual representation of visible components comprise instructions to concatenate a page identifier and one or more component identifiers.

9. (canceled)

10. A method comprising:
receiving a request for a web page from a requesting customer;
generating a visibility fingerprint for the web page, prior to rendering the web page, based at least in part on web page components and one or more visibility rules accessed from a web page database, wherein generating the visibility fingerprint comprises traversing components of the web page, creating a textual representation of visible components, and hashing the textual representation;
determining if a web page identified by the visibility fingerprint is in a cache, prior to rendering the web page;
when the web page identified by the visibility fingerprint is not in the cache, rendering the web page based at least in part on the web page components and the visibility rules and storing the web page in the cache;
retrieving the web page from the cache when the web page identified by the visibility fingerprint is in the cache;
and
returning the web page to the requesting customer.

11. The method of claim 10, comprising applying the visibility rules to define conditions under which web page components are visible in the web page during rendering.

12. The method of claim 10, wherein the conditions define a segment of customers to receive the web page.

13. The method of claim 10, wherein the visibility fingerprint is unique for the web page.

14. The method of claim 10, wherein generating the visibility fingerprint is faster than rendering the web page.

15. (canceled)

16. The method of claim 10, wherein traversing the components of the web page comprises traversing nested components.

17. The method of claim 10, wherein creating the textual representation of visible components comprises concatenating a page identifier and one or more component identifiers.

18. (canceled)

19. A non-transitory machine-readable storage medium having instructions stored therein, which when executed by one or more processors of a computing device, causes the computing device to:
receive a request for a web page from a requesting customer;
generate a visibility fingerprint for the web page, prior to rendering the web page, based at least in part on web page components and one or more visibility rules accessed from a web page database, wherein instructions to generate the visibility fingerprint comprise instructions to traverse components of the web page, create a textual representation of visible components, and hash the textual representation;
determine if a web page identified by the visibility fingerprint is in a cache, prior to rendering the web page;
when the web page identified by the visibility fingerprint is not in the cache, render the web page based at least in part on the web page components and the visibility rules and store the web page in the cache;
and
return the web page to the requesting customer.

20. (canceled)

21. The non-transitory machine-readable storage medium of claim 19, wherein instructions to traverse the components of the web page comprise instructions to traverse nested components.

22. The non-transitory machine-readable storage medium of claim 19, wherein instructions to create the textual representation of visible components comprise instructions to concatenate a page identifier and one or more component identifiers.

23. (canceled)
